(19) United States
(12) Patent Application Publication
(10) Pub. No.: US 2008/0053272 A1
(43) Pub. Date: Mar. 6, 2008

(54) Mechanical vibrator with adjustable vibratory effect

(75) Inventors: Turo Keski-Jaskari, Vantaa (FI); Matti Kosonen, Jarvenpaa (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/506,742

(22) Filed: Aug. 18, 2006

(51) Int. Cl. F16H 35/00

(52) U.S. Cl. 74/840

(57) ABSTRACT

A mechanical vibrator is provided. The vibrator includes a drive, a shaft connected to the drive, and a weight connected to the shaft. The drive is adapted to rotate the shaft and the shaft is adapted to bend during rotation.

### BACKGROUND OF THE INVENTION

1. Field of the Invention

The teachings in accordance with the exemplary embodiments of this invention relate generally to a mechanical vibrator and, more specifically, relate to an adjustable mechanical vibrator.

2. Brief Description of Prior Developments

Mechanical vibrators are employed in conventional electronic devices for a variety of purposes. Mobile phones and pagers utilize a mechanical vibrator to provide a vibrating notification of incoming calls or messages. Game controllers utilize a mechanical vibrator to provide the user with a vibratory effect in the controller, to simulate game mechanics, for example. Conventional mechanical vibrators are generally either binary, having a vibratory effect or no vibratory effect, or have very few vibration settings, as few as two or three that vary only in the strength of the vibratory effect.

### SUMMARY

In an exemplary aspect of the invention, a mechanical vibrator is provided. The vibrator includes a drive, a shaft connected to the drive, and a weight connected to the shaft. The drive is adapted to rotate the shaft and the shaft is adapted to bend during rotation.

In another exemplary aspect of the invention, a method is provided. The method is for providing a user with feedback and includes the following steps. A mechanical vibrator is provided. The mechanical vibrator includes a drive, a shaft connected to the drive, and a weight connected to the shaft. The shaft is rotated by the drive, wherein the shaft bends as the shaft is rotated.

In a further exemplary aspect of the invention, a hand-held, portable electronic device is provided. The electronic device includes: a mechanical vibrator comprising a drive, a shaft connected to the drive, and a weight connected to the shaft, wherein the drive is adapted to rotate the shaft and wherein the shaft is adapted to bend during rotation; and at least one input device coupled to the mechanical vibrator.

In another exemplary aspect of the invention, another hand-held, portable electronic device is provided. The electronic device includes: at least one data processor; at least one memory coupled to the at least one data processor; at least one input device coupled to the at least one data processor; at least one display device coupled to the at least one data processor; and a mechanical vibrator coupled to the at least one data processor, wherein the mechanical vibrator comprises a drive, a shaft connected to the drive, and a weight connected to the shaft, wherein the drive is adapted to rotate the shaft and wherein the shaft is adapted to bend during rotation.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 shows a mechanical vibrator incorporating features of the invention;

FIG. 2 shows the mechanical vibrator of FIG. 1 with a motor operating at a relatively middle range rotations per minute (RPM);

FIG. 3 shows the mechanical vibrator of FIG. 1 with a motor operating at a relatively high RPM;

FIG. 4 shows another embodiment of a mechanical vibrator incorporating features of the invention;

FIG. 5 shows the mechanical vibrator of FIG. 4 with a motor having begun to rotate a shaft of the mechanical vibrator;

FIG. 6 shows the mechanical vibrator of FIGS. 4 and 5 with the motor rotating the shaft and a weight having reached a second stopper;

FIG. 7 shows the mechanical vibrator of FIG. 4 with the motor rotating the shaft in the opposite direction (counter clockwise) from that shown in FIGS. 5 and 6 and the weight having reached a first stopper;

FIG. 8 shows another embodiment of a mechanical vibrator incorporating features of the invention;

FIG. 9 shows a weight of the mechanical vibrator depicted in FIG. 8;

FIG. 10 shows the mechanical vibrator of FIG. 8 with a motor having begun to rotate a shaft of the mechanical vibrator;

FIG. 11 shows the mechanical vibrator of FIGS. 8 and 10 with the motor rotating the shaft and a weight having reached a first stopper;

FIG. 12 shows the mechanical vibrator of FIG. 8 with the motor rotating the shaft in the opposite direction (clockwise) from that shown in FIGS. 10 and 11 and the weight having reached a second stopper;

FIG. 13 shows the mechanical vibrator of FIG. 12 with the motor operating at an increased RPM;

FIG. 14 shows a flow chart illustrating an exemplary method for practicing the exemplary embodiments of the invention;

FIG. 15 shows a simplified block diagram of a hand-held, portable electronic device that is suitable for use in practicing the exemplary embodiments of the invention; and

FIG. 16 shows a simplified block diagram of another hand-held, portable electronic device that is suitable for use in practicing the exemplary embodiments of the invention.

### DETAILED DESCRIPTION

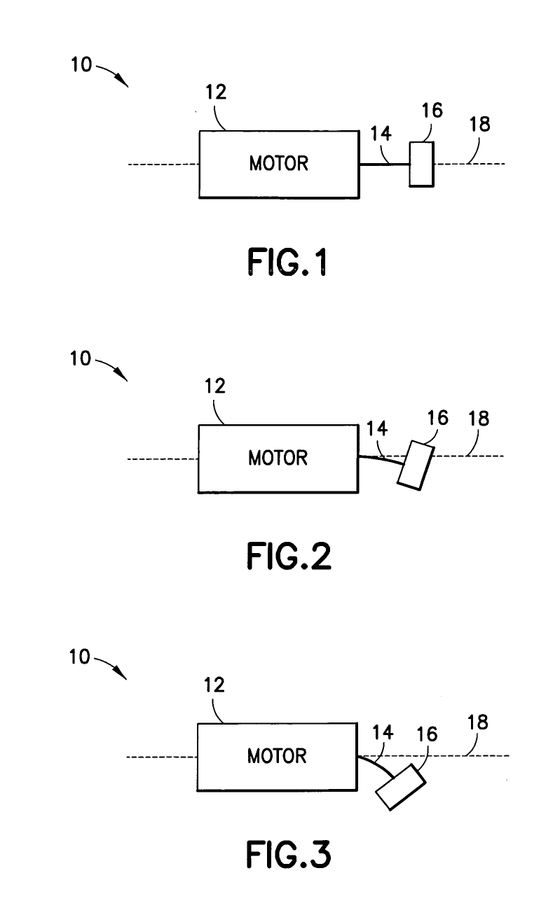

Referring to FIG. 1, there is shown a mechanical vibrator 10 incorporating features of the invention. Although the invention will be described with reference to the exemplary embodiments shown in the drawings, it should be understood that the invention can be embodied in many alternate forms of embodiments. In addition, any suitable size, shape or type of elements or materials could be used.

The mechanical vibrator 10 generally comprises a motor 12, a load shaft 14 coupled to the motor at a first end of the load shaft 14 and a weight 16 coupled to a second end of the load shaft 14. The motor 12 comprises an electric motor for rotating the shaft 14. Any suitable type of motor for rotating the shaft could be provided. The weight 16 can comprise any suitable type of weight. In this embodiment the weight 16 has a center of mass aligned with the center axis of the shaft 14. However, in an alternate embodiment the center of mass of the weight might be misaligned relative to the center axis of the shaft.

The load shaft 14 comprises a wire made of superelastic or shape memory alloy material, such as NITINOL for example. Due to its composition, the shape of the load shaft 14 is adapted to deform based on the rotations per minute (RPM) output of the motor 12 and the effect of the weight 16 on the load shaft 14. At relatively low RPM, the load shaft 14 is substantially straight and substantially aligned along a central longitudinal axis 18, as shown in FIG. 1. Since the load shaft 14 is substantially aligned along the axis 18, the weight 16 is also substantially aligned along the axis 18. Because the weight 16 is substantially aligned along the axis 18, no vibratory effect is generated by the mechanical vibrator 10. A vibratory effect is generated by the mechanical vibrator 10 when a center of the weight is at least partially offset from the axis 18.

Referring also to FIG. 2, the mechanical vibrator 10 of FIG. 1 is shown with the motor 12 operating at a relatively middle range RPM. The shape of the load shaft 14 is resiliently deformed or deflected from the former substantially straight shape of FIG. 1. As the RPM increase and the load shaft 14 is deformed, the centrifugal force on the weight 16 deflects the weight 16 from aligning with the axis 18. This deflection generates a vibratory effect that is proportional to the relative amount of deflection. Although the center of mass of the weight 16 is aligned with the shaft 14, the weight 16 will move off-center from the axis 18 because of its cantilevered positioning with the shaft 14 and initial relatively small forces, such as wind resistance or motion of the vibrator 10 for example.

Referring also to FIG. 3, the mechanical vibrator 10 of FIG. 2 is shown with the motor 12 operating at a relatively high RPM. The shape of the load shaft 14 is further deformed from the shape of the load shaft 14 in FIG. 2. This additional deformation is due to the increased RPM. As the load shaft 14 further deforms, the force on the weight 16 further deflects the weight 16 from aligning with the axis 18. The further deflection of the weight 16 generates a stronger vibratory effect than that of the mechanical vibrator 10 as shown in FIG. 2. In such a manner, the strength of the vibratory effect generated by the mechanical vibrator 10 can be controlled because the strength of the vibratory effect is proportional to the RPM output of the motor 12.

Although the shape of the load shaft 14 is adapted to deform based on the RPM output of the motor 12 and the effect of the weight 16 on the load shaft 14, the deformation of the load shaft 14 does not have to occur at the first moment of rotation. Deformation of the load shaft 14 may occur only after a certain rotational speed (such as a predetermined rotational speed, for example) is achieved.

Since the deflection of the weight 16 from the axis 18 is determined by the deformation of the load shaft 14, as influenced by the RPM output of the motor 12, the weight 16 itself does not need to be unbalanced. An unbalanced weight is a weight whose center of mass does not substantially align with a center longitudinal axis of the rotating shaft. Unbalanced weights are generally employed in mechanical vibrators to achieve a vibratory effect. The weight 16 may weigh about the same as, or less than, weights in conventional rotating mechanical vibrators.

In other embodiments, an unbalanced weight may be employed in conjunction with the flexible load shaft 14 of FIGS. 1-3. In such embodiments, a vibratory effect may be generated even when the motor is operating at a relatively low RPM. Although the load shaft would not be deformed, the unbalanced weight would generate a vibratory effect. As the RPM output of the motor is increased, the load shaft would deform and the vibratory effect produced by the mechanical vibrator would increase. In such a manner, using a flexible load shaft and an unbalanced weight it may be possible to generate a stronger vibratory effect with a smaller RPM output of the motor as compared with conventional, fixed-shaft mechanical vibrators.

In further embodiments, the load shaft may comprise any suitable material(s) (e.g. flexible material) such that the shape of the shaft is adapted to deform based on the RPM output of the motor and the effect of the weight on the shaft.

In other embodiments, the shaft may include screw threads along its length. In further embodiments, the weight may be threadingly connected (e.g. threaded on) the screw threads of the shaft.

In other embodiments, when a vibratory effect is not desired, the motor 12 may run at a low rotational speed without generating a vibratory effect. In such a manner, should a vibratory effect be desired, the motor 12 can increase the rotational speed of the drive shaft to generate a vibratory effect without first needing to be turned on. Such embodiments enable rapid feedback rise-time to minimize the delay before a vibratory effect can be generated by the mechanical vibrator 10.

In further embodiments, the vibratory effect generated by the mechanical vibrator 10 is in response to or proportional to elements in a game, such as a car engine's RPM, as a non-limiting example.

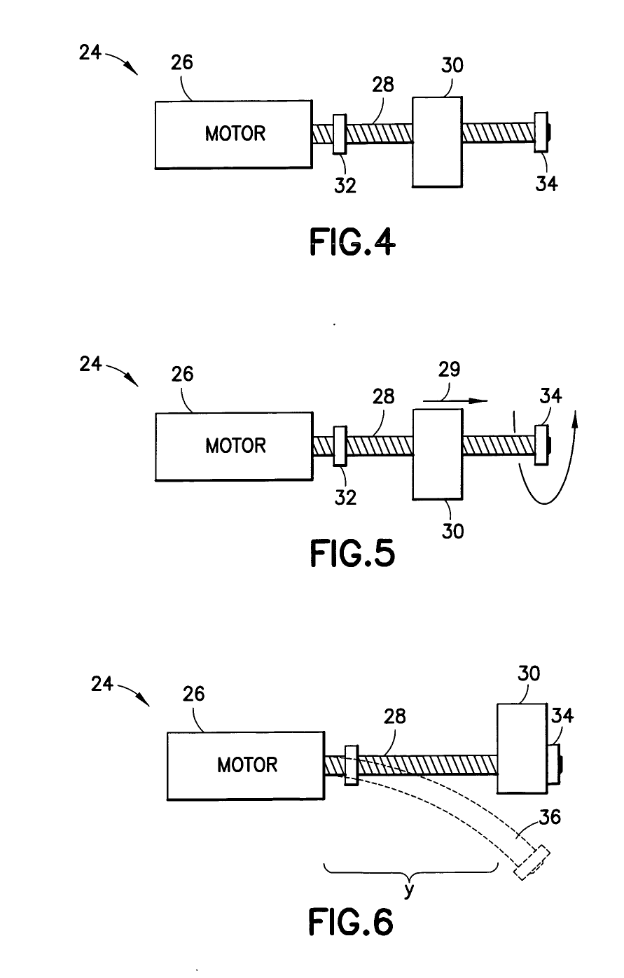

Referring to FIG. 4, there is shown another embodiment of a mechanical vibrator 24 incorporating features of the invention. The mechanical vibrator 24 generally comprises a motor 26, a screw threaded flexible shaft 28 coupled to the motor 26 at a first end of the shaft 28, an unbalanced weight 30 movably mounted on the shaft 28 and two stoppers 32, 34. A first stopper 32 is located towards the first end of the shaft 28 proximate the motor 26. A second stopper 34 is located towards a second end of the shaft 28 distal from the motor 26. The weight 30 is movably located between the first stopper 32 and the second stopper 34. The weight 30 is adapted to engage the screw threads of the shaft 28. In the embodiment shown, the shaft 28 is comprised of a superelastic material, such as a shape memory material. Thus, the shaft 28 is adapted to resiliently bend numerous times without permanent deformation. However, in an alternate embodiment the shaft 28 could be comprised of any suitable type of material(s).

When the motor 26 begins to rotate the shaft 28, the weight 30 does not initially turn with the shaft 28 because of the inertia of the weight 30 and the high speed of rotation of the shaft 28. Instead, because of the threaded connection between the weight 30 and the screw threads of the shaft 28, the weight 30 moves longitudinally along the shaft 28 until the weight 30 reaches an end position abutting one of the stoppers 32, 34. The direction the weight 30 moves, towards the first stopper 32 or towards the second stopper 34, depends on the direction of the rotation of the shaft 28 and the screw threads on the shaft 28. The characteristics of the generated vibratory effect depend on the torque differences between the two end positions of the weight 30, at the stopper 32 or at the stopper 34. The torque differences stem from the rotating shaft length difference (i.e. where the weight 30 is located along the shaft 28 while the weight 30 is rotating and producing a vibratory effect).

Referring also to FIG. 5, the mechanical vibrator 24 of FIG. 4 is shown with the motor 26 having begun to rotate the shaft 28. As shown in FIG. 5, the shaft 28 is being rotated in a clockwise direction relative to the motor 26 output. The rotation of the shaft 28 and the screw threading of the shaft 28 help move the weight 30 in the direction 29 indicated, towards the second stopper 34.

Referring also to FIG. 6, the mechanical vibrator 24 of FIGS. 4 and 5 is shown with the motor 26 rotating the shaft 28 and the weight 30 having reached the second stopper 34. Having moved along the shaft 28 until reaching the second stopper 34, the weight 30 can move no further along the shaft 28. In this position, the weight 30 then rotates with the shaft 28. Since the weight 30 is unbalanced, this rotation produces a vibratory effect. Note that the length of the rotating shaft 28, as measured from the motor 26 to the weight 30, has a length y.

Since the shaft 28 is comprised of a superelastic material, the shape of the shaft 28 is adapted to deform based on the RPM output of the motor 26 and the effect of the weight 30 on the shaft 28, as further explained above with respect to the embodiment of FIGS. 1-3. As illustrated in FIG. 6, at increased RPM the shape of the shaft 36 is resiliently deformed or deflected from the former substantially straight shape (e.g. the shape of the shaft 28).

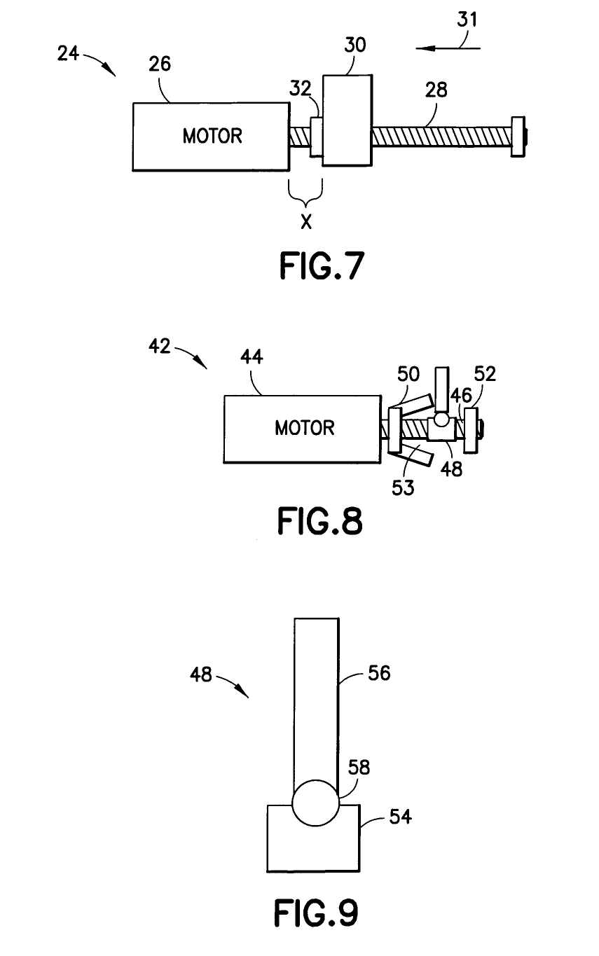

Referring to FIG. 7, the mechanical vibrator 24 of FIG. 4 is shown with the motor 26 rotating the shaft 28 in the opposite direction (counter clockwise) from FIGS. 5 and 6 and the weight 30 having reached the first stopper 32. Similar to FIG. 6, because the weight 30 has reached the first stopper 32, the weight 30 can move no further along the length of the shaft in direction 31 and the weight 30 now rotates with the shaft 28. As the weight 30 is unbalanced, this rotation produces a vibratory effect. Here, the length of the rotating shaft 28, as measured from the motor 26 to the weight 30, has a length x. The different length x of the rotating shaft 28, as compared to the length y in FIG. 6, produces a different vibratory effect than that of the mechanical vibrator 24 as shown in FIG. 6. In one embodiment, y=2x. In other embodiments, the values x and y may be related by any suitable mathematical relationship.

Referring to FIG. 8, there is shown another embodiment of a mechanical vibrator 42 incorporating features of the invention. The mechanical vibrator 42 generally comprises a motor 44, a screw threaded flexible shaft 46 coupled to the motor 44 at a first end of the shaft 46, an unbalanced weight 48 movably mounted on the shaft 46 and two stoppers 50, 52. A first stopper 50 is located towards the first end of the shaft 46. A second stopper 52 is located towards a second end of the shaft 46. The first stopper 50 is shaped to form a cavity 53 facing towards the second end of the shaft 46. The weight 48 is located between the first stopper 50 and the second stopper 52. The weight 48 is adapted to engage the screw threading of the shaft 46. In the embodiment shown, the shaft 46 is comprised of a superelastic material, such as a shape memory material. Thus, the shaft 46 is adapted to resiliently bend numerous times without permanent deformation. However, in an alternate embodiment the shaft 46 could be comprised of any suitable type of material(s).

When the motor 44 begins to rotate the shaft 46, the weight 48 does not initially turn with the shaft 46 because of the inertia of the weight 48 and the high speed of rotation of the shaft 46. Instead, because of the inertia and the threaded engagement between the weight 48 and the screw threads of the shaft 46, the weight 48 moves longitudinally along the shaft 46 until the weight 48 reaches an end position abutting one of the stoppers 50, 52. The direction the weight 48 moves, towards the first stopper 50 or towards the second stopper 52, depends on the direction of the rotation of the shaft 46 and the screw threading on the shaft 46. The characteristics of the generated vibratory effect depend on the torque differences between the two end positions of the weight 48. The torque differences stem from the rotating shaft length difference (i.e. where the weight 48 is located along the shaft 46 while the weight 48 is rotating and producing a vibratory effect) and the different distances between the center of mass of the weight 48 and the center of the shaft 46 as further explained below.

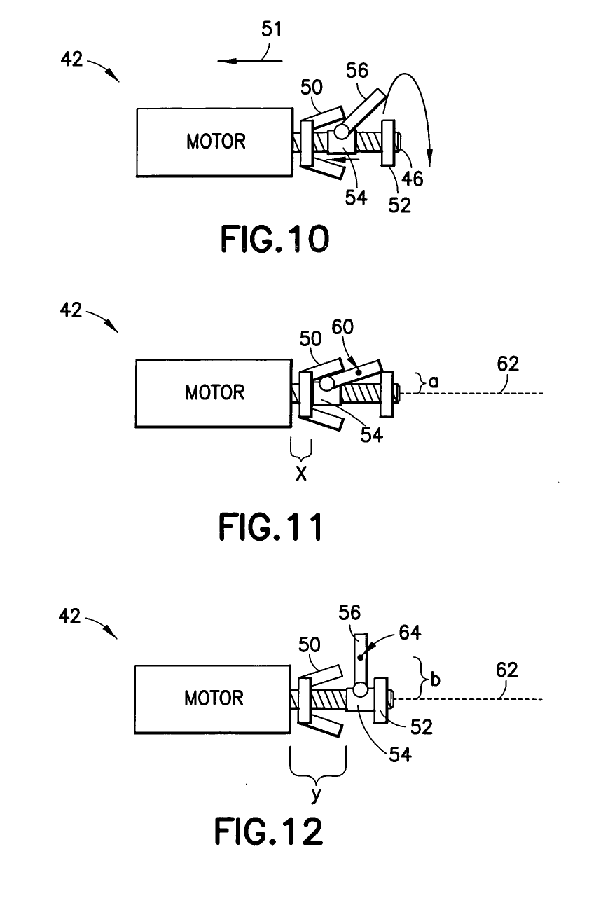

Referring also to FIG. 9, there is shown the weight 48 of the mechanical vibrator 42 of FIG. 8. The weight 48 comprises a first part 54 coupled to a second part 56 by a bearing joint 58. The bearing joint 58 enables the second part 56 to move relative to the first part 54 as further explained below.

Referring also to FIG. 10, the mechanical vibrator 42 of FIG. 8 is shown with the motor 44 having begun to rotate the shaft 46. As shown in FIG. 10, the shaft 46 is being rotated in a counter clockwise direction relative to the motor 44 output. The rotation of the shaft 46 and the screw threading of the shaft 46 help move the weight 48 in the direction 51 indicated, towards the first stopper 50. As the weight 48 moves towards the first stopper 50, the second part 56 of the weight 48 comes into contact with the first stopper 50. Due to the cavity shape of the first stopper 50 and the bearing joint 58 of the weight 48, the first part 54 of the weight 48 continues to move towards the first stopper 50 even after the second part 56 of the weight 48 has come into contact with the first stopper 50. The second part 56 is deflected towards the shaft 46.

Referring also to FIG. 11, the mechanical vibrator 42 of FIGS. 8 and 10 is shown with the motor 44 rotating the shaft 46 and the first part 54 of the weight 48 having reached the first stopper 50. Having moved along the shaft 46 until reaching the first stopper 50, the first part 54 of the weight 48 can move no further. In this position, the weight 48 then rotates with the shaft 46. Since the weight 48 is unbalanced, this rotation produces a vibratory effect. As shown in FIG. 11, the rotating weight 48 has a center of mass (COM) 60. As measured from a centerline 62 of the rotating shaft 46, the distance to the COM 60 is a value a.

Referring also to FIG. 12, the mechanical vibrator 42 of FIG. 8 is shown with the motor 44 rotating the shaft 46 in the opposite direction (clockwise) from FIGS. 10 and 11 and the weight 48 having reached the second stopper 52. As with the first stopper 50 in FIG. 11, having reached the second stopper 52 the weight 48 can move no further and rotates with the shaft 46. As the weight 48 is unbalanced, this rotation produces a vibratory effect. In FIG. 12, since the second stopper 52 is not cavity shaped as is the first stopper 50, the second part 56 of the weight 48 remains fully extended while the weight 48 is rotating with the shaft 46. In such a manner, the rotating weight 48 of FIG. 12 has a different center of mass (COM) 64 relative to the shaft 46 than the rotating weight 48 as shown in FIG. 11. As measured from a centerline 62 of the rotating shaft 46, the distance to the COM 64 is a value b. The different distance b to the COM 64 and the different length y of the rotating shaft 46, as compared to the distance a and length x in FIG. 11, produce a different vibratory effect than that of the mechanical vibrator 42 as shown in FIG. 11.

In other embodiments, the values a and b may be related by a suitable mathematical relationship. In one embodiment b=2a, for example.

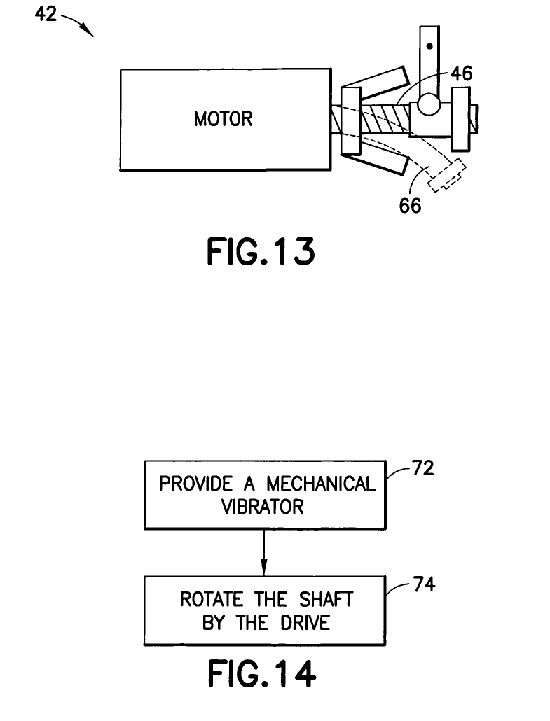

Referring also to FIG. 13, the mechanical vibrator 42 of FIG. 12 is shown with the motor 44 operating at an increased RPM. Since the shaft 46 is comprised of a superelastic material, the shape of the shaft 46 is adapted to deform based on the RPM output of the motor 44 and the effect of the weight 48 on the shaft 46, as further explained above with respect to the embodiment of FIGS. 1-3. As illustrated in FIG. 13, at increased RPM the shape of the shaft 66 is resiliently deformed or deflected from the former substantially straight shape (e.g. the shape of the shaft 46).

Although the weight of the vibrator in the embodiment of FIGS. 8-13 is shown as having two parts with the first part movably threaded on the threads of the shaft and the second part movably connected to the first part, other embodiments of the invention may include different configurations of the weight. Such embodiments enable the vibrator to achieve different vibratory effects by varying the distance of the center of mass of the weight from the rotating shaft. As a non-limiting example, the weight 48 might be provided as a spring-loaded weight (spring loaded towards the shaft) such that the cavity shaped stopper 50 might not be needed. The center of mass of the spring-loaded weight may be made to vary based on the longitudinal position of the weight along the rotating shaft and/or the rotational speed of the rotating shaft, as non-limiting examples.

Although the vibrators shown above in the embodiments of FIGS. 4-7 and 8-13 include the shaft having threads and the weight movably threaded on the threads of the shaft, other embodiments of the invention may include any suitable system wherein rotation of the shaft moves the weight longitudinally with respect to the shaft. As a non-limiting example, a rack and pinion system may be employed.

As described above, and particularly with respect to the embodiments of FIGS. 4-7 and 8-13, the vibrator may be configured such that bending of the flexible shaft does not result in binding of the weight and the shaft with one another. As a non-limiting example, the vibrator may have a loose engagement between the weight and the shaft. As non-limiting examples of such a loose engagement, the weight may be loosely threaded on the shaft or, if a rack and pinion system is employed, there may be a loose engagement between the rack and the pinion.

Referring to FIG. 14, a flow chart is shown illustrating an exemplary method for practicing the exemplary embodiments of the invention. The method includes the following steps. In box 72, a mechanical vibrator is provided. The mechanical vibrator comprises a drive, a shaft connected to the drive, and a weight connected to the shaft. The drive is adapted to rotate the shaft and the shaft is adapted to bend during rotation. In box 74, the shaft is rotated by the drive. The shaft bends as the shaft is rotated.

In other embodiments, the method may further comprise controlling a direction of rotation of the drive. In further embodiments, the method may further comprise varying a rotational speed output of the drive.

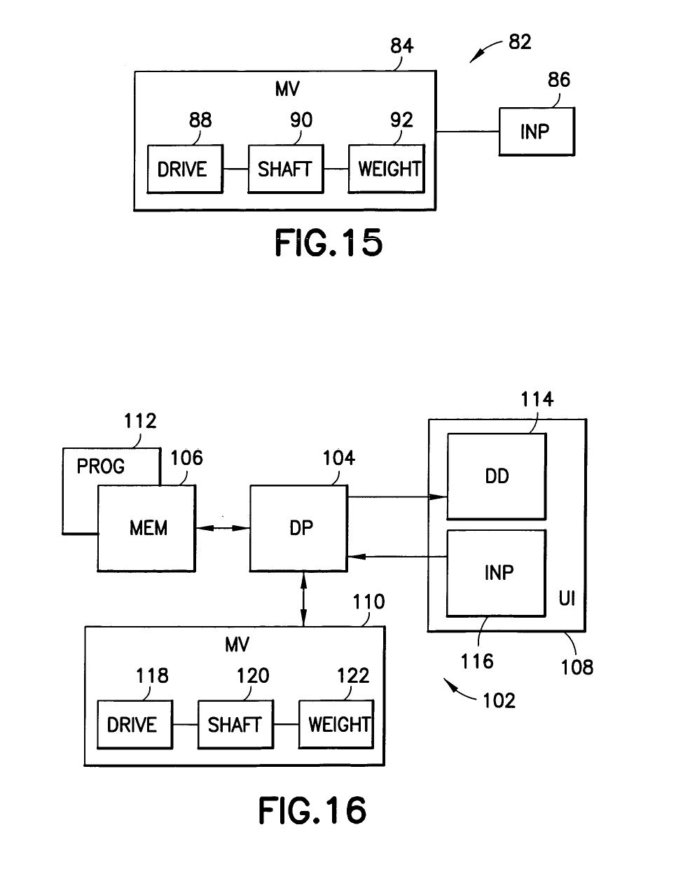

Referring to FIG. 15, a simplified block diagram of another hand-held, portable electronic device 82 that is suitable for use in practicing the exemplary embodiments of the invention is shown. The electronic device 82 comprises a mechanical vibrator (MV) 84 coupled to an input device (INP) 86. The MV 84 comprises a drive 88, a shaft 90 connected to the drive, and a weight 92 connected to the shaft 90. The drive 88 is adapted to rotate the shaft 90. The shaft 90 is adapted to bend during rotation. The INP 86 comprises any input device, analog or digital, by which a user may provide input to the electronic device 82. As one non-limiting example, the INP 86 may comprise a button. In response to a user pressing the button, the MV 84 would provide the user with feedback in the form of a vibratory effect. As another non-limiting example, the INP 86 may comprise a pressure-sensitive digital button. In response to the pressure a user exerts on the button, the MV 84 would provide the user with variable feedback in the form of a variable vibratory effect. One non-limiting example of the electronic device 82 is a game controller having at least one button.

In other embodiments, the shaft 90 may comprise a superelastic material. In further embodiments, a center of mass of the weight 92 may not substantially align with a center longitudinal axis of the shaft 90.

Referring to FIG. 16, a simplified block diagram of a hand-held, portable electronic device 102 that is suitable for use in practicing the exemplary embodiments of the invention is shown. The electronic device 102 comprises: a data processor (DP) 104, a memory (MEM) 106 coupled to the DP 104, a user interface (UI) 108 coupled to the DP 104, and a mechanical vibrator (MV) 110 coupled to the DP 104. The MEM 106 stores a program (PROG) 112. The PROG 112 is assumed to include program instructions that, when executed by the DP 104, enable the electronic device 102 to operate in accordance with the exemplary embodiments of this invention, as discussed herein. The UI 108 comprises a display device (DD) 114 and an input device (INP) 116. The INP 116 comprises any input device, analog or digital, by which a user may provide input to the electronic device 102. The MV 110 comprises a drive 118, a shaft 120 connected to the drive, and a weight 122 connected to the shaft 120. The drive 110 is adapted to rotate the shaft 120. The shaft 120 is adapted to bend during rotation.

In other embodiments, the shaft 120 may comprise a superelastic material. In further embodiments, a center of mass of the weight 122 may not substantially align with a center longitudinal axis of the shaft 120. In other embodiments, the electronic device 102 may further comprise a transceiver coupled to the DP 104.

The MEM 106 may be of any type suitable to the local technical environment and may be implemented using any suitable data storage technology, such as semiconductor-based memory devices, magnetic memory devices and systems, optical memory devices and systems, fixed memory and removable memory, as non-limiting examples. The DP 104 may be of any type suitable to the local technical environment, and may include one or more of general purpose computers, special purpose computers, microprocessors, digital signal processors (DSPs) and processors based on a multi-core processor architecture, as non-limiting examples.

In general, the various embodiments of the electronic device 102 can include, but are not limited to, cellular telephones, personal digital assistants (PDAs), portable computers, image capture devices such as digital cameras, gaming devices, music storage and playback appliances, Internet appliances, as well as portable units or terminals that incorporate combinations of such functions.

This invention describes ways to implement a vibrator or vibratory motor that gives at least two types of feedbacks or has an adjustable vibratory effect. Difference in the feedbacks arises from varying the effective length of the rotating shaft and/or varying the distance of the rotating mass from its rotating axis, and the torque difference generated by these variations. The changes in the geometry of the system affect the optimum resonance frequency of the rotation, and thus generate different types of feedback for the user. The mode of the feedback is selectable by either the direction of rotation of the shaft or by the speed of the rotation.

The foregoing description has provided, by way of exemplary and non-limiting examples, a full and informative description for carrying out the invention. However, various modifications and adaptations may become apparent to those skilled in the relevant art in view of the foregoing description, when read in conjunction with the accompanying drawings and the appended claims.

Furthermore, some of the features of the preferred embodiments described above could be used without the corresponding use of other features. As such, the foregoing description should be considered as merely illustrative of the invention, and not limiting the invention.

What is claimed is:

1. A mechanical vibrator comprising:
a drive;
a shaft connected to the drive, wherein the drive is adapted to rotate the shaft and wherein the shaft is adapted to bend during rotation; and
a weight connected to the shaft.

2. A mechanical vibrator as in claim 1 wherein the shaft comprises a superelastic material.

3. A mechanical vibrator as in claim 1 wherein the shaft comprises screw threads along a longitudinal length thereof.

4. A mechanical vibrator as in claim 3 wherein the weight is threadingly connected to the screw threads of the shaft.

5. A mechanical vibrator as in claim 1 wherein the weight is stationarily fixed to the shaft at a fixed location.

6. A mechanical vibrator as in claim 1 wherein the weight is movably located on the shaft.

7. A mechanical vibrator as in claim 1 wherein the weight comprises at least two pieces which are movable relative to each other.

8. A mechanical vibrator as in claim 7 wherein the weight comprises a reconfigurable weight assembly.

9. A mechanical vibrator as in claim 1 wherein a center of mass of the weight does not substantially align with a center longitudinal axis of the shaft.

10. A mechanical vibrator as in claim 1 further comprising:
a first stopper coupled to the shaft towards a first end of the shaft; and
a second stopper coupled to the shaft towards a second end of the shaft, wherein the shaft has threads, wherein the weight is movably threaded on the threads of the shaft, and wherein the weight is located between the first stopper and the second stopper.

11. The mechanical vibrator of claim 10 wherein a center of mass of the weight does not substantially align with a center longitudinal axis of the shaft.

12. The mechanical vibrator of claim 10 wherein the shaft comprises a superelastic material.

13. A mechanical vibrator as in claim 10 wherein the weight comprises a reconfigurable weight assembly.

14. The mechanical vibrator of claim 13, wherein the reconfigurable weight assembly comprises a first part and a second part, wherein the first part is movably threaded on the threads of the shaft and the second part is movably connected to the first part.

15. The mechanical vibrator of claim 14 wherein the first stopper comprises a cavity facing towards the second end of the shaft.

16. The mechanical vibrator of claim 13 wherein the reconfigurable weight assembly comprises a spring-loaded weight.

17. The mechanical vibrator of claim 13 wherein the shaft comprises a superelastic material.

18. A method for providing a user with feedback in a portable, hand-held device comprising:
providing the device with a mechanical vibrator comprising a drive, a shaft connected to the drive, and a weight connected to the shaft, wherein the drive is adapted to rotate the shaft and wherein the shaft is adapted to bend during rotation; and
rotating the shaft by the drive, wherein the shaft bends as the shaft is rotated.

19. The method of claim 18 further comprising controlling a direction of rotation of the drive.

20. The method of claim 18 further comprising varying a rotational speed output of the drive.

21. A hand-held, portable electronic device comprising:
a mechanical vibrator comprising a drive, a shaft connected to the drive, and a weight connected to the shaft, wherein the drive is adapted to rotate the shaft and wherein the shaft is adapted to bend during rotation; and
at least one input device coupled to the mechanical vibrator.

22. The electronic device of claim 21 wherein the shaft comprises a superelastic material.

23. The electronic device of claim 21 wherein a center of mass of the weight does not substantially align with a center longitudinal axis of the shaft.

24. A hand-held, portable electronic device comprising:
at least one data processor;
at least one memory coupled to the at least one data processor;
at least one input device coupled to the at least one data processor;
at least one display device coupled to the at least one data processor; and
a mechanical vibrator coupled to the at least one data processor, wherein the mechanical vibrator comprises a drive, a shaft connected to the drive, and a weight connected to the shaft, wherein the drive is adapted to rotate the shaft and wherein the shaft is adapted to bend during rotation.

25. The electronic device of claim 24 wherein the shaft comprises a superelastic material.

26. The electronic device of claim 24 wherein a center of mass of the weight does not substantially align with a center longitudinal axis of the shaft.

27. The electronic device of claim 24 further comprising a transceiver coupled to the at least one data processor.
